(19) United States
(12) Patent Application Publication
(10) Pub. No.: US 2018/0144288 A1
(43) Pub. Date: May 24, 2018

(54) SYSTEM FOR INVENTORY MANAGEMENT

(71) Applicants: Sajeed Sayed, Shrewsbury, MA (US); Archana Kamath, Shrewsbury, MA (US); Anand Sharma, Shrewsbury, MA (US)

(72) Inventors: Sajeed Sayed, Shrewsbury, MA (US); Archana Kamath, Shrewsbury, MA (US); Anand Sharma, Shrewsbury, MA (US)

(21) Appl. No.: 15/359,854

(22) Filed: Nov. 23, 2016

(51) Int. Cl. G06Q 10/08; H04L 29/08; H04W 4/00

(52) U.S. Cl. CPC G06Q 10/087; H04W 84/12; H04W 4/008; H04L 67/10

(57) ABSTRACT

An automated system for tracking inventory is provided. The automated system tracks the sufficiency of an inventory by the weight of the items composing the inventory so that resulting inventory deficiencies can be automatically sensed either continuously or periodically at predetermined polling intervals through container transducers coupled to a WIFI enabled microprocessor, wherein the microprocessor posts the weight-based output of the transducers to a cloud server that determines if the weight-based output signifies an inventory deficiency by comparing it to a predetermined threshold. A user may through their computer set the predetermined threshold and polling intervals. The user may also export the cloud server determinations in the form of alerts back to their computer or to registered user-suppliers for replenishing the deficient inventory.

### BACKGROUND OF THE INVENTION

The present invention relates to inventory management and, more particularly, to an automated system for tracking stocked inventory by weight.

Typically, the only way to identify that an inventory is depleted or out of stock is by visual inspection, and once the inventory deficiency has been identified, and the only way to correct said deficiency is to place an order manually. This is especially true for household groceries because at present time there is no automatic way of identifying when inventory is below a predetermined threshold and no associated ability to process an order automatically to modify the inventory accordingly.

As can be seen, there is a need for an automated system for tracking stocked inventory by weight so that inventory deficiencies, such as being out of stock, can be automatically identified and replenished, wherein the inventory system is automatically updated for deficiency and tracking purposes.

### SUMMARY OF THE INVENTION

In one aspect of the present invention, a computer-implemented method for tracking an inventory includes providing a cloud server; storing on the cloud server a predetermined threshold for each item of the inventory; providing a container for each item of the inventory; coupling at least one load cell to each container, wherein each load cell provides a programmable microprocessor; and transmitting the output of each load cell via the programmable microprocessor to the cloud server, wherein the cloud server compares the output of each load cell to its respective predetermined threshold.

In another aspect of the present invention, the computer-implemented method for tracking an inventory includes providing a cloud server; storing on the cloud server a predetermined threshold for each item of the inventory; providing a container for each item of the inventory; coupling at least one load cell to each container, wherein each load cell provides a programmable microprocessor, wherein the programmable microprocessor provides a Bluetooth modality and WIFI capability for transmitting the output of each load cell; programming the programmable microprocessor to wake up each load cell only at an associated predetermined polling interval; and transmitting the output of each load cell via the programmable microprocessor to the cloud server, wherein the cloud server compares the output of each load cell to its respective predetermined threshold, wherein the cloud server sends an alert if the output of each load cell is less than its respective predetermined threshold, and wherein the alert includes the respective predetermined threshold and the respective output of each load cell.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is an exploded view of an exemplary embodiment of the present invention;

FIG. 3 is a schematic view of an exemplary embodiment of the present invention;

FIG. 4 is a schematic view of an exemplary embodiment of the present invention;

FIG. 5A is a schematic view of an exemplary embodiment of a setup mode of the present invention;

FIG. 5B is a schematic view of an exemplary embodiment of the setup mode of the present invention;

FIG. 5C is a schematic view of an exemplary embodiment of the setup mode of the present invention;

FIG. 6 is a schematic view of an exemplary embodiment of an automated tracking and notification mode of the present invention; and

FIG. 7 is a schematic view of an exemplary embodiment of an automatic order of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an automated system for tracking inventory aggregated by weight so that resulting inventory deficiencies can be automatically sensed and identified, wherein the system interconnects consumer and supplier users so that sensed deficiencies may be automatically replenished through automated notification between associated consumer users and supplier users.

### Computer-Implemented Method

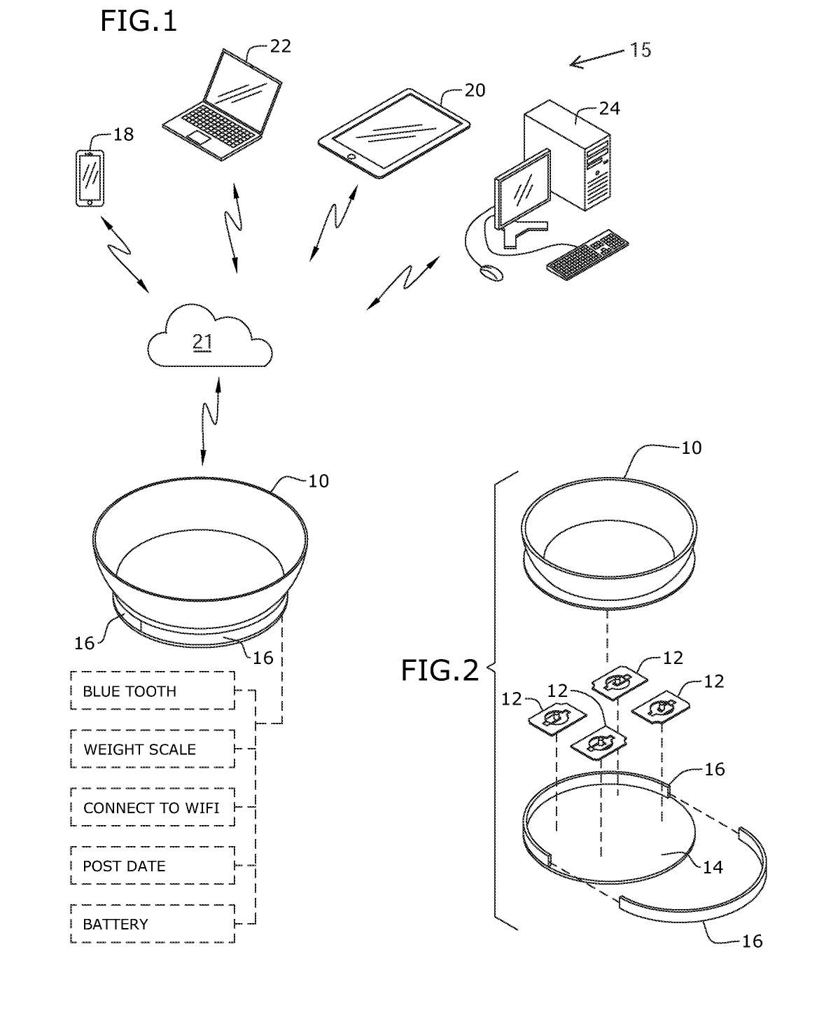

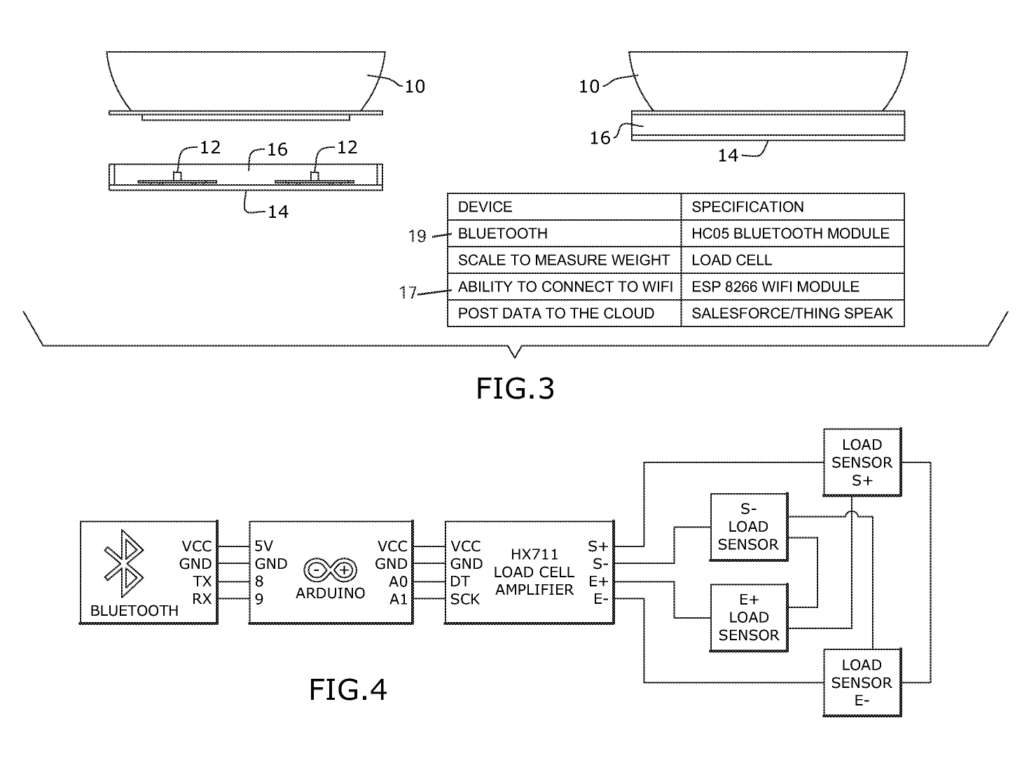

Referring to FIG. 1, The present invention may include a computer 15 having Bluetooth capability. The computer 15 may include at least one processing unit coupled to a form of memory, such as, but not limited to, a desktop 24, laptop 22, cloud server 21, and smart device 20, such as, a tablet and smart phone 18. The computer 15 may include a program product including a machine-readable program code for causing, when executed, the computer 15 to perform steps. The program product may include software which may either be loaded onto the computer or accessed by the computer 15. The loaded software may include an application on the smart device 20. The software may be accessed by the computer 15 using a web browser. The computer 15 may access the software via the web browser using the internet, extranet, intranet, host server, a cloud server 21, and the like.

### Container

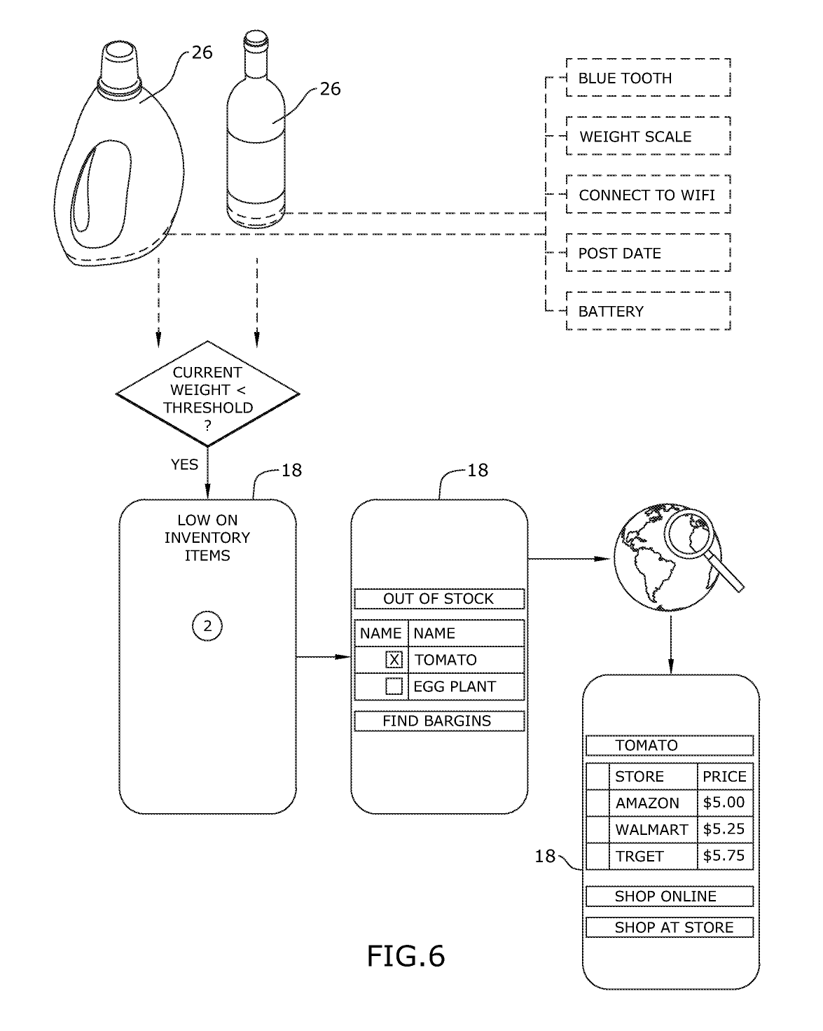

Referring to FIG. 2, the present invention may include a container 10 which may be fitted with at least one load cell 12, an amplifier, such as a HX711 amplifier, a Bluetooth modality 19, such as Hc-05 Bluetooth module or other technology for exchanging data over short distances, and a WIFI enabled microprocessor 17, such as ARDUINO ESP 8266 WIFI module. Each load cell 12 may be a transducer adapted so that an electrical signal is created that is directly proportional in magnitude of a mass in the container 10 being measured by the transducer, wherein each load cell 12 may be electrically coupled to the container 10 for removably retaining the mass. In certain embodiments, each load cell 12 may be provided in a housing 16 of a base 14 of the container 10. In a specific embodiment, each housing 16 may provide four load cells 12 as shown in FIGS. 2 and 4, wherein the four load cells 12 include a S+, S−, E+ and an E− load cell 12 as arranged in the schematic of FIG. 4. In some embodiments, the retainer may be an enclosed container 26 with a built-in load cell 12 or cells 12, as illustrated in FIG. 6.

### Configuring the System and Registering the User/Device

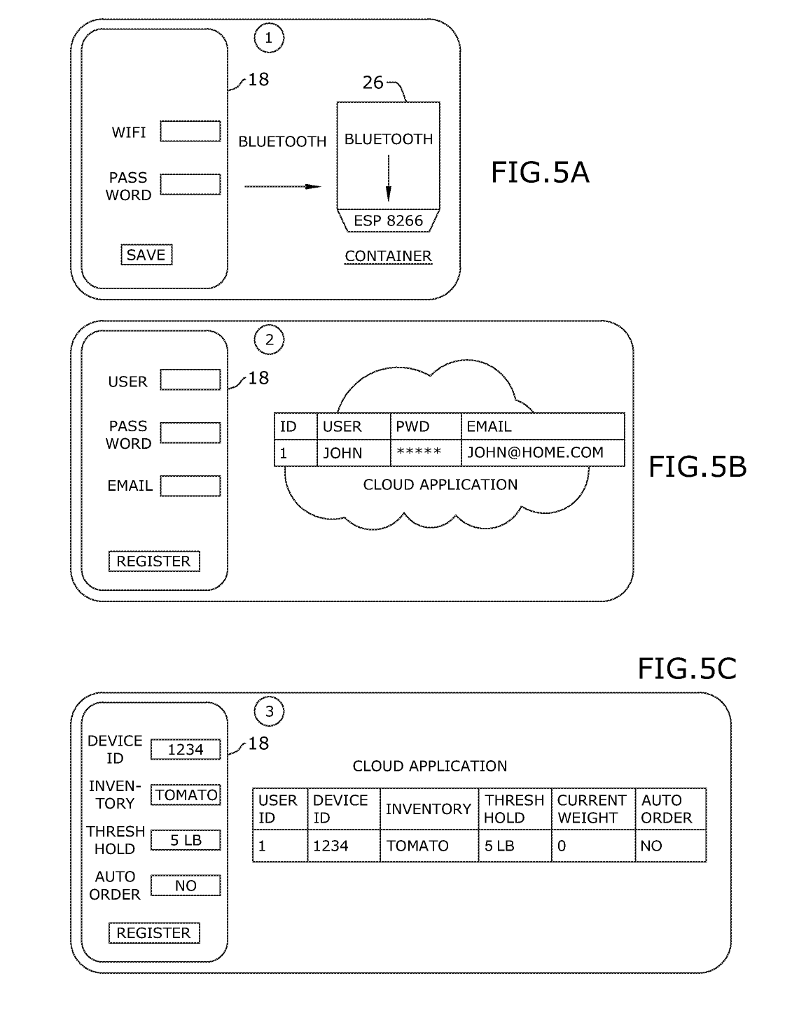

Referring to FIGS. 5A, 5B and 5C, the computer 18 may use its Bluetooth capability to communicate with the Bluetooth modality 19 on the container 10 to provide WIFI name, password, and at least one predetermined polling interval to the microprocessor 17. The predetermined polling intervals may be time intervals at which time the microprocessor 17 will trigger the mass/weight measurement (e.g., mass/weight output) through each associated at least one load cell 12. Also at the predetermined polling interval(s), the microprocessor 17, through its WIFI capabilities, may export/post the mass/weight measurement data on the cloud server 21.

### Processing

Referring to FIG. 6, processing will be done in the cloud server 21. The cloud server 21 may contain at least one predetermined mass threshold for each item of an inventory, wherein each predetermined mass threshold may be a value of mass/weight. The respective predetermined mass threshold(s) may be transmitted to the cloud server 21 via the computer 15, as illustrated in FIG. 1. Upon receiving the load cell 12 mass/weight output from the relevant container 10 via the microprocessor 17, the cloud server 21 may execute the logic of comparing the predetermined threshold value of the associated item against the new weight (output) posted by microprocessor 17. If a mass/weight output is less than its respective predetermined threshold, then the cloud server 21 may send an alert to at least one user through their computer(s) 15, possibly via a user interface or other signaling device.

### Purchasing

Replenishing inventory deficiencies may take several forms, including but not limited to the following:
1. User can make an in-store purchase and check the inventory status on their computer 15;
2. User can look for bargain on the internet using their computer 15; and
3. User can also be redirected to online store such as Amazon to complete the purchase

### Implementation

The container 10 or 26 of the present invention can be used to retain an item of an inventor, for example, apples possessed by a household or a store. The user can use their computer 15 to set the predetermined threshold mass/weight of the apples after which a mass/weight of apples less than said predetermined threshold could be quantified as low inventory or a deficient item of the inventory. The container 10 or 26 may be weighted periodically at the predetermined polling interval(s) by associated load cell 12 and the resulting mass/weight output sent to the cloud server 21 via the microprocessor 17. The cloud server 21 may be adapted to compare the mass/weight output to the predetermined threshold saved by the user earlier. If the posted mass/weight output is less than the predetermined threshold weight a notification/alert may be sent to the user. As a result, when the user is in the grocery store he knows exactly what to order since he has list of all the grocery/inventory items, in this example apples, that are below the predetermined threshold weight. The user can simply buy the items and check them in the computer 15 as ordered. He can also choose not to go to the store and continue the purchase experience on via a mobile application which can look for the best prices of the item. Also, the user could hook up the mobile application with online warehouse such as Amazon, possibly through Amazon API.

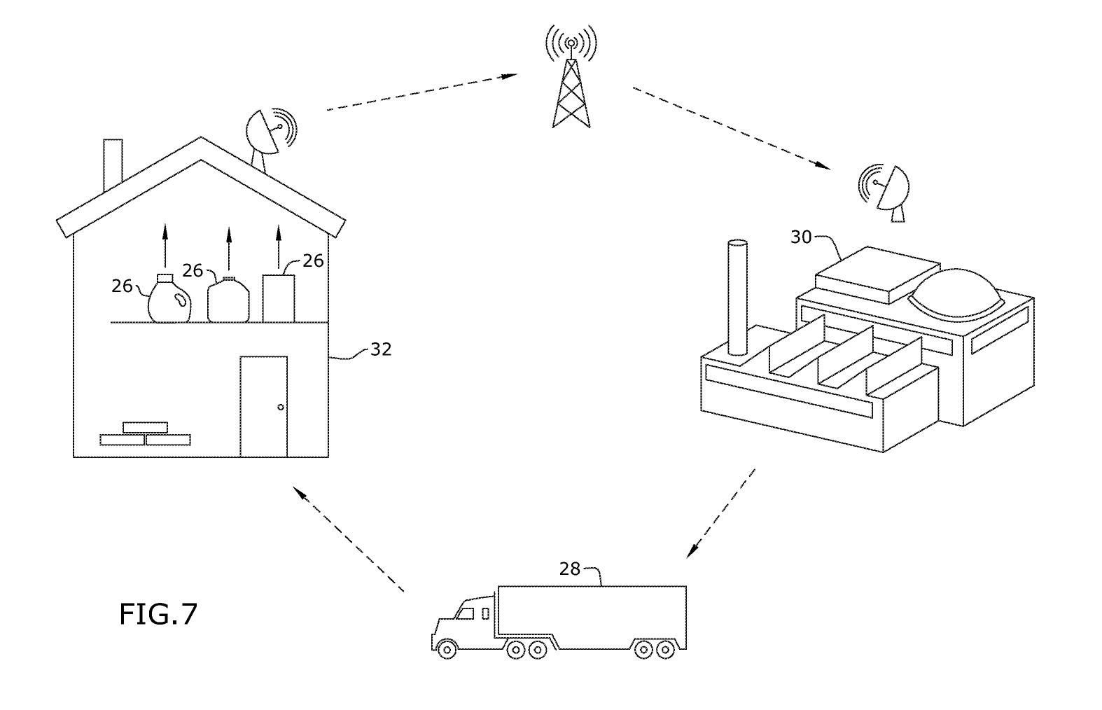

In another embodiment, the present invention may be adapted so that a plurality of associated/registered users, such as a user-supplier 30 and/or a user-consumer 32, may access the same weight/mass outputs associated with an inventory of goods posted to the cloud server 21, wherein the present invention enables the plurality of users to track, manage, and modify the inventory via a delivery method 28, such as by a delivery truck, of inventory-related goods. The system may be integrated in the above-mentioned container 26 for automatically managing the amount of household items. Furthermore, the present invention may be adapted to transmit notifications/alerts to the plurality of associated/registered users, thereby facilitating a modification the inventory via the delivery method 28 by, for example, facilitating a fulfillment order of the user-consumer 32 by way of the user-supplier 30, as illustrated FIG. 7.

Similarly, for factories, if an associated warehouse has an API, the present invention may be adapted to automatically order from the factory. For example, if the present invention is integrated in a tide box, so that when the tide is over, the present invention can directly post mass/weight output signals to the cloud server 21 so that a registered user-supplier 32 warehouse may replenish any inventory deficiency, removing the middle man from the equation.

From the tracking output, resulting automated notification, and the like, a user may generate purchase trends for home and industries. The present invention may incorporate predictive analysis and forecast models that based on tracking trends, may replenishment at specified dates, managing resources and obtaining the best deal.

The present invention can also be used for any industry that likes to track their inventory, such as doctors tracking their patient's usage of medication.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented method for tracking an inventory, comprising:
providing a cloud server;
storing on the cloud server a predetermined threshold for each item of the inventory;
providing a container associated with each item of the inventory;
coupling at least one load cell to each container, wherein each load cell comprises a programmable microprocessor; and
transmitting an output of the at least one load cell via the programmable microprocessor to the cloud server, wherein the cloud server compares the output of the at least one load cell to its respective predetermined threshold,
whereby each container is enabled to weigh its associated item of the inventory and transmit said output for comparison to the respective predetermined value of said associated item.

2. The method of claim 1, wherein the cloud server sends an alert if the output of each load cell is less than its respective predetermined threshold.

3. The method of claim 1, further including programming the programmable microprocessor to wake up each load cell only at an associated predetermined polling interval.

4. The method of claim 1, further including programming the programmable microprocessor to transmit the output of each load cell at an associated predetermined polling interval.

5. The method of claim 1, wherein the programmable microprocessor provides a Bluetooth modality and WIFI capability for transmitting the output of each load cell.

6. The method of claim 2, wherein the alert includes the respective predetermined threshold and the respective output of each load cell.

7. The method of claim 6, further comprising transmitting the alert to an API of a supplier.

8. A computer-implemented method for tracking an inventory, comprising:
providing a cloud server;
storing on the cloud server a predetermined threshold for each item of the inventory;
providing a container for each item of the inventory;
coupling at least one load cell to each container, wherein each load cell comprises a programmable microprocessor, wherein the programmable microprocessor provides a Bluetooth modality and WIFI capability for transmitting the output of each load cell;
programming the programmable microprocessor to wake up each load cell only at an associated predetermined polling interval; and
transmitting the output of each load cell via the programmable microprocessor to the cloud server, wherein the cloud server compares the output of each load cell to its respective predetermined threshold, wherein the cloud server sends an alert if the output of each load cell is less than its respective predetermined threshold, and wherein the alert includes the respective predetermined threshold and the respective output of each load cell.
